(19) United States
(12) Patent Application Publication
(10) Pub. No.: US 2008/0012874 A1
(43) Pub. Date: Jan. 17, 2008

(54) Dynamic selection of high-performance pixel shader code based on check of restrictions

(76) Inventors: Steven J. Spangler, El Dorado Hills, CA (US); William B. Sadler, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/486,686

(22) Filed: Jul. 14, 2006

(51) Int. Cl. G09G 5/00

(52) U.S. Cl. 345/582

(57) ABSTRACT

Apparatus, systems and methods for the dynamic selection of high-performance pixel shader code based on check of restrictions are disclosed. For example, a method is disclosed including receiving a graphics primitive for rendering, determining whether the graphics primitive satisfies a restriction, and selecting from at least two versions of rendering code a first version of rendering code to render the graphics primitive if the graphics primitive satisfies the restriction. Other implementations are also disclosed.

### BACKGROUND

3D rendering engines may be tasked with rendering a wide variety of graphical primitives. A rendering engine will typically process more data (i.e., use greater data widths or precision) to accurately render complex primitives such as polygons undergoing rotation. However, when rendering less complex primitives, such as those utilized for “blit” type operations, a rendering engine may be able to use lower precision data.

All rendering engines are limited in the amount of graphics data that can be delivered or computed in a given period of time. Hence, using high precision data to render complex primitives reduces an engine's throughput while lowering the precision of the data can improve that throughput. Sometimes two different rendering codes can be provided: one “lower performance” version that operates at high precision with reduced throughput and one “higher performance” version that operates at lower precision with increased throughput. A typical graphics driver may choose to employ either the higher or the lower performance version of the rendering code. However, because it has limited up-front visibility as to whether the higher performance version can be used it, a graphics driver will usually employ the lower performance, higher precision rendering code for all rendering tasks. This means that for simpler rendering tasks the rendering engine may not be operating at maximum efficiency.

### BRIEF DESCRIPTION OF THE DRAWINGS

The accompanying drawings, incorporated in and constituting a part of this specification, illustrate one or more implementations consistent with the principles of the invention and, together with the description of the invention, explain such implementations. The drawings are not necessarily to scale, the emphasis instead being placed upon illustrating the principles of the invention. In the drawings,

FIG. 1 illustrates portions of a 3D rendering engine in accordance with some implementations of the invention;

FIG. 2 is a flow chart illustrating a process in accordance with some implementations of the invention; and

FIG. 3 illustrates a system in accordance with some implementations of the invention.

### DETAILED DESCRIPTION

The following description refers to the accompanying drawings. Among the various drawings the same reference numbers may be used to identify the same or similar elements. While the following description provides a thorough understanding of the various aspects of the claimed invention by setting forth specific details such as particular structures, architectures, interfaces, techniques, etc., such details are provided for purposes of explanation and should not be viewed as limiting. Moreover, those of skill in the art will, in light of the present disclosure, appreciate that various aspects of the invention claimed may be practiced in other examples or implementations that depart from these specific details. At certain junctures in the following disclosure descriptions of well known devices, circuits, and methods have been omitted to avoid clouding the description of the present invention with unnecessary detail.

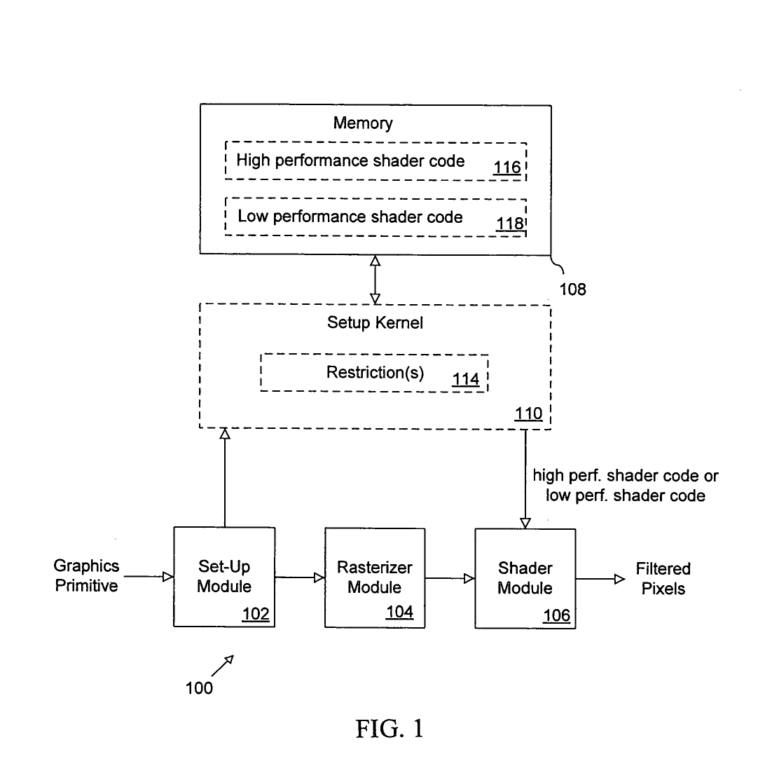

FIG. 1 is a simplified block diagram of portions of a 3D rendering engine 100 in accordance with some implementations of the claimed invention. Engine 100 may include a set-up module 102, a rasterizer module 104, a pixel shader module 106, and memory 108. Those skilled in the art will recognize that some components typically found in a 3D rendering engine (e.g., vertex shader, texture sampler(s), etc.) and not particularly germane to the claimed invention have been excluded from FIG. 1 so as not to obscure implementations of the invention. Moreover, while FIG. 1 illustrates one pixel shader 106, those skilled in the art will recognize that more than one shader may be implemented without departing from the scope and spirit of the claimed invention.

In addition, those skilled in the art may recognize that a 3D rendering engine, such as engine 100, may be tasked with rendering pixels in a compositing context in which the engine may undertake 3D operations that may include rendering objects having textures that exhibit rotation or perspective relative to pixel coordinate space and other rendering operations, such as “blit”-type operations, in which textures may be aligned to pixel coordinate space. For example, those skilled in the art will recognize that such a compositing context may be encountered when using a 3D rendering engine to render High Definition Digital Video Disc (HD-DVD) data that includes both 3D data streams and 2D data streams where the 3D data streams may convey graphics primitives including higher precision (i.e., larger data width) graphics data while the 2D data streams may convey primitives including lower precision (i.e., smaller data width) graphics data. However, the invention is not limited to compositing contexts, HD-DVD or otherwise.

Set-up module 102 may be capable of receiving graphics primitives, such as triangle primitives, and may process those primitives to determine parameters required for rasterization of the primitives in pixel or screen coordinates. For example, set-up module 102 may determine the pixel coordinates defining the outline of a triangle in screen space. Set-up module 102 may also, for example, undertake depth-testing of each primitive to determine whether each primitive is viewable (i.e., not occluded by another primitive). Those skilled in the art will recognize that set-up module 102 may undertake a variety of other primitive processing tasks that will not be described in greater detail herein.

Rasterizer 104 may be capable of processing graphics primitives, such as triangle primitives, provided by setup module 102 to generate attributes associated with the primitive where those attributes may be defined in a pixel or “screen” coordinate system. In doing so, rasterizer 104 may generate attributes for each pixel encountered in traversing, for example, a given triangle by interpolating triangle vertex coordinates (e.g., (u, v) vertex texture coordinates). Rasterizer 104 may then provide pixels and associated attributes to shader 106 for per-pixel processing.

Those skilled in the art may recognize that elements of engine 100, such as rasterizer 104 may generate pixel fragments where such pixel fragments may comprise integer x and y grid coordinates, a color value, depth values, etc. in addition to texture coordinates for a given pixel. However, for the most part, such details are beyond the scope of the invention and, in order to not obscure description of implementations of the invention, the term “pixel” or “pixel data” will be used throughout this disclosure even though those skilled in the art may recognize that rasterizer 104 may provide shader 106 with pixel fragments (e.g., including pixel texture addresses). Hence, for example, while shader 106 may be described as generating filtered pixel fragments (i.e., filtered pixel color values), in the interests of clarity this disclosure will describe shader 106 as generating filtered pixels.

Engine 100 further includes a set-up kernel 110 associated with set-up module 102 and comprising a software and/or firmware algorithm that may undertake computations on graphics data associated with graphics primitives received by set-up module 102. Set-up kernel 110 may be coupled, at least, to shader 106 and memory 108.

In accordance with some implementations of the invention, set-up kernel 110 may compare certain properties of a graphics primitive received by set-up module 102 to one or more restriction(s) 114. Set-up kernel 110 may then, based on that comparison, dynamically determine whether that primitive should be processed by shader 106 using a high performance version 116 of render or shader kernel or code held in memory 108 or using a low performance version 118 of render or shader kernel or code held in memory 108. In accordance with some implementations of the invention, kernel 110 may undertake assessments or computations that generate certain properties or characteristics of a graphics primitive and may use those properties to decide which version of shader code to supply to shader 106. Those capabilities, functions or actions of kernel 110 in accordance with some implementations of the invention may be described collectively as selection logic and will be described in greater detail below.

Memory 108 may comprise any memory device or mechanism suitable for storing and/or holding two or more versions 116, 118 of rendering or shader code and for providing those versions or rendering code to kernel 110 and/or shader 106. While memory 108 may comprise any volatile or non-volatile memory technology such as Random Access Memory (RAM) memory or Flash memory, the invention is in no way limited by the type of memory employed for use as memory 108.

Pixel shader 106 may comprise any pixel shader logic including any combination of hardware, software, and/or firmware, capable of per-pixel processing of graphics primitives received from rasterizer 104. For example, shader 106 may comprise a programmable execution unit. While those skilled in the art will recognize that pixel shaders such as shader 106 often undertake processes such as implementing various per pixel shading routines, such specific functionality is outside the scope of the invention and will not be discussed further. In accordance with some implementations of the invention as will be explained in greater detail below, shader 106 may further be capable of processing, on a per pixel basis, graphics primitives using either the high performance shader code 116 or the low performance shader code 118.

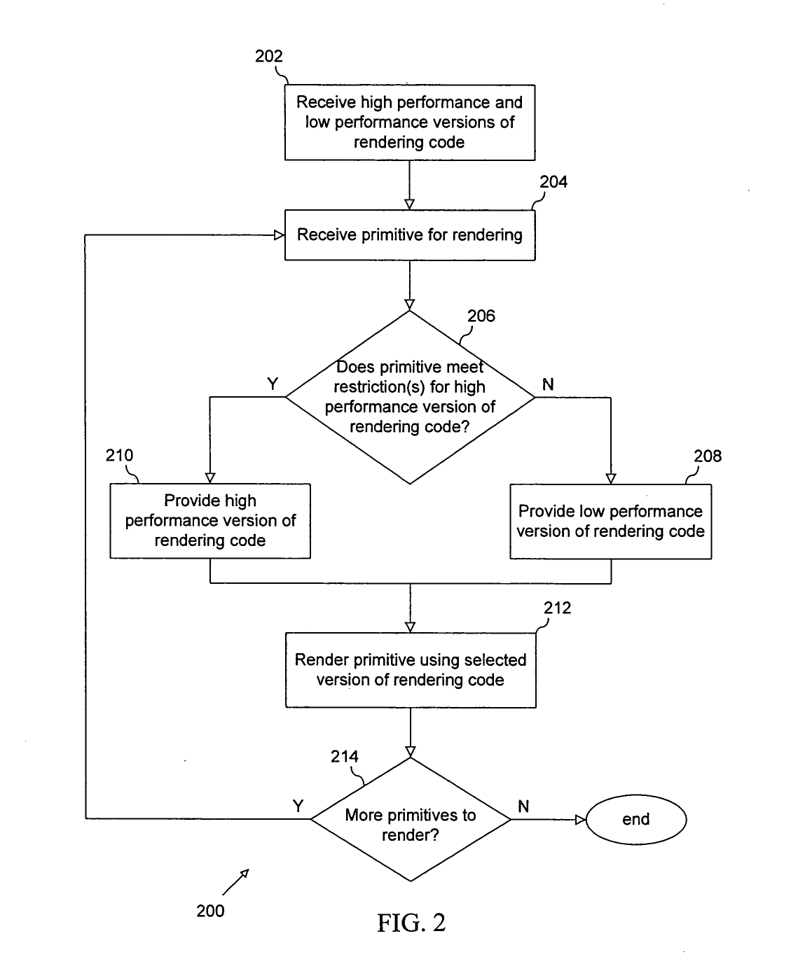

FIG. 2 is a flow chart illustrating a process 200 in accordance with some implementations of the invention. While, for ease of explanation, process 200 may be described with regard to engine 100 of FIG. 1, the claimed invention is not limited in this regard and other processes or schemes supported by appropriate devices in accordance with the claimed invention are possible.

Process 200 may begin with receiving both high and low performance versions of rendering code [act 202]. In some implementations of the invention, act 202 may involve a software application placing shader kernel code versions 116 and 118 in memory 108. The invention, is, however, not limited to receiving the two code versions in a single step such as act 202. Thus, for example, in other implementations of the invention, act 202 may comprise two distinct actions of receiving one version of the code and then receiving the other version of the code.

Although the invention is not limited to specific implementations of high performance or low performance rendering codes, those skilled in the art will recognize that some primitives, such as those specifying polygons exhibiting rotation, may need to be rendered or shaded using relatively low performance rendering code that is capable of rendering high precision or larger width data at lower throughput rates, while other primitives, such as those specifying 2D windows for example, may be rendered or shaded using relatively high performance rendering code that is capable of rendering lower precision or lower width data at higher throughput rates.

Process 200 may continue with the receipt of a primitive for rendering [act 204]. In some implementations of the invention, set-up module 102 may receive a graphics primitive for processing. Process 200 may then continue with a determination of whether that primitive satisfies or meets one or more restrictions for processing using the high performance version of the rendering code [act 206]. In some implementations of the invention, act 206 may be undertaken by set-up kernel 110 where kernel 110 may compare certain properties of the primitive, provided to kernel 110 by set-up module 102, to one or more restriction(s) 114 to determine whether that primitive is suitable for processing using the high performance version of the rendering code 118 held in memory 108.

Restriction(s) 114 may comprise criteria that properties or characteristics of a graphics primitive may be compared to. For example, restriction(s) 114 may be based upon a spatial relationship between a primitive's texture coordinates and that primitive's pixel coordinates. The invention is not limited, however, to restriction(s) 114 being based on any spatial relationship between a primitive's texture coordinates and that primitive's pixel coordinates. Thus, for example, restriction(s) 114 may comprise criteria based upon the nature of a graphical primitive's data format.

A couple of example implementations may help illustrate how act 204 may be implemented. In one implementation, a graphics primitive may be provided to set-up module 102 in act 204 and, in undertaking act 206, set-up kernel 110 may calculate or determine derivatives of the texture coordinates with respect to the pixel coordinates of that primitive. In other words, in this example, set-up kernel 110 may calculate or determine the quantities (du/dx) and (dv/dy) for that primitive. Kernel 110 may then use those values to determine whether or not that primitive can be processed by shader 106 using the high performance version 116 of the shader's rendering code. If, for example, both derivatives du/dx and dv/dy have a value of one then kernel 110 may determine in act 206 that the primitive is suitable for processing by shader 106 using the high performance version 116 of the shader's rendering code because the texture of that primitive is aligned to the pixel coordinates. Thus, in this example, restriction(s) 114 may include a requirement that both derivatives du/dx and dv/dy must have at least a certain value or range of values in order for an associated primitive to be suitable for processing by the high performance version of the rendering code.

In a second example implementation, a graphics primitive may be provided to set-up module 102 in act 204 and, in undertaking act 206, set-up kernel 110 may determine the format of the graphics data associated with that primitive. In other words, in this example, set-up kernel 110 may assess the texture data format of that primitive and use that information to determine whether or not that primitive can be processed by shader 106 using the high performance version 116 of the shader's rendering code. If, for example, kernel 110 determines that the primitive's texture data is in an integer or a fixed-point format then kernel 110 may determine in act 206 that the primitive is suitable for processing by shader 106 using the high performance version 116 of the shader's rendering code because the texture data is not of a high-precision nature (i.e., has smaller data widths). If, on the other hand, kernel 110 determines that the primitive's texture data is in floating-point format then kernel 110 may determine in act 206 that the primitive is not suitable for processing by shader 106 using the high performance version 116 of the shader's rendering code because the texture data is of a high-precision nature (i.e., has larger data widths). Thus, in this example, restriction(s) 114 may include a requirement that texture data not be in a floating-point format for an associated primitive to be suitable for processing by the high performance version of the rendering code.

If the result of act 206 is negative, that is, if kernel 110 determines that the primitive does not meet the restriction(s) for the high performance version of the rendering code, then process 200 may continue with the selection or provision of the low performance version of the rendering code [act 208]. Act 208 may be done by having kernel 110 obtain the low performance shader code 118 from memory 108 and provide that low performance code to shader 106. If, on the other hand, the result of act 206 is positive, that is, if kernel 110 determines that the primitive does meet the restriction(s) for the high performance version of the rendering code, then process 200 may continue with the selection or provision of the high performance version of the rendering code [act 210]. Act 210 may be done by having kernel 110 obtain the high performance shader code 116 from memory 108 and provide that high performance code to shader 106. The invention is not, however, limited by the manner in which the code is provided in acts 208 or 210. Thus, for example, in other implementations of the invention, kernel 110 may undertake either of acts 208 or 210 by instructing shader 106 on the appropriate version of code to obtain from memory 108.

Process 200 may then continue with the rendering of the primitive using the provided or selected version of the code [act 212]. In some implementations of the invention, act 212 may involve shader 106 using the version of the code provided in act 208 or act 210 to render the primitive received in act 204 and provided to shader 106 by rasterizer 104. Because the invention is not limited to a particular high performance rendering code or to a particular low performance rendering code the exact nature of the rendering undertaken in act 212, whether using high performance or low performance rendering code, will not be described in further detail herein.

Process 200 may then continue with a determination of whether additional primitives are to be rendered [act 214]. In some implementations of the invention, act 214 may be undertaken by a graphics driver (not shown) which may recognize that additional graphics primitives are to be rendered. If there are more primitives for rendering then acts 204-210 may be repeated for each of those primitives. If there are no more primitives for rendering then process 200 may end.

In accordance with some implementations of the invention, process 200 may be employed to determine dynamically, on a per-primitive basis, whether pixels of a given primitive can be shaded or rendered using a high performance version of the rendering code. In other words, in one iteration of acts 204-212 a first primitive, such as a primitive specifying a 2D window, may be received in act 204, be determined to be meet the restriction(s) for rendering using the high performance version of the rendering code in act 206, and then rendered in act 212 using that high performance version of the rendering code provided in act 210. A subsequent primitive, such as a primitive specifying a 3D polygon undergoing rotation, may, in another iteration of acts 204-212, be received in act 204, be determined to not meet the restriction(s) for rendering using the high performance version of the rendering code in act 206, and then rendered in act 212 using that low performance version of the rendering code provided in act 208.

The acts shown in FIG. 2 need not be implemented in the order shown; nor do all of the acts necessarily need to be performed. Also, those acts that are not dependent on other acts may be performed in parallel with the other acts. For example, acts 202 and 204 may be undertaken in parallel. Further, at least some of the acts in this figure may be implemented as instructions, or groups of instructions, implemented in a machine-readable medium.

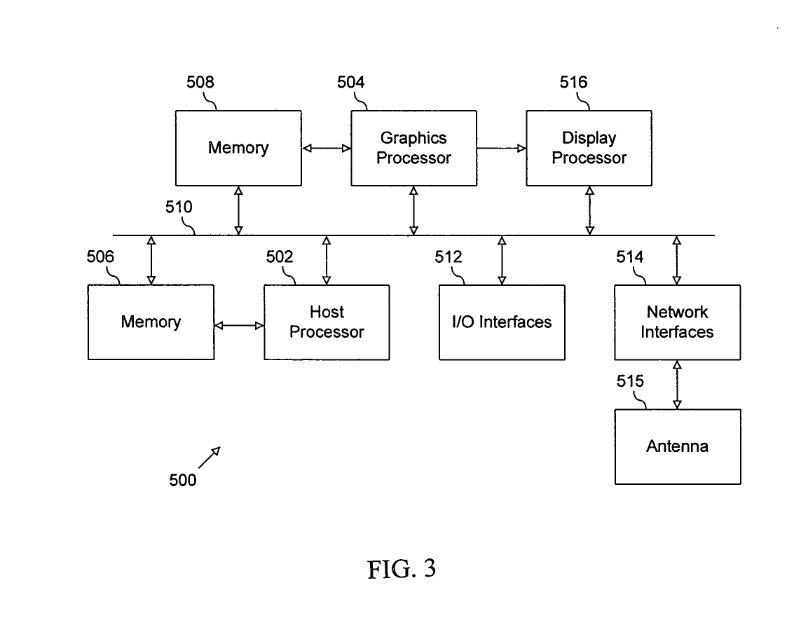

FIG. 3 illustrates an example system 500 in accordance with some implementations of the invention. System 500 may include a host processor 502, a graphics processor 504, memories 506 and 508 (e.g., dynamic random access memory (DRAM), static random access memory (SRAM), non-volatile memory, etc.), a bus or communications pathway(s) 510, input/output (I/O) interfaces 512 (e.g., universal synchronous bus (USB) interfaces, parallel ports, serial ports, telephone ports, and/or other I/O interfaces), network interfaces 514 (e.g., wired and/or wireless local area network (LAN) and/or wide area network (WAN) and/or personal area network (PAN), and/or other wired and/or wireless network interfaces), and a display processor and/or controller 516. System 500 may also include an antenna 515 (e.g., dipole antenna, narrowband Meander Line Antenna (MLA), wideband MLA, inverted “F” antenna, planar inverted “F” antenna, Goubau antenna, Patch antenna, etc.) coupled to network interfaces 514. System 500 may be any system suitable for processing 3D graphics data and providing that data in a rasterized format suitable for presentation on a display device (not shown) such as a liquid crystal display (LCD), or a cathode ray tube (CRT) display to name a few examples.

System 500 may assume a variety of physical implementations. For example, system 500 may be implemented in a personal computer (PC), a networked PC, a server computing system, a handheld computing platform (e.g., a personal digital assistant (PDA)), a gaming system (portable or otherwise), a 3D capable cellular telephone handset, etc. Moreover, while all components of system 500 may be implemented within a single device, such as a system-on-a-chip (SOC) integrated circuit (IC), components of system 500 may also be distributed across multiple ICs or devices. For example, host processor 502 along with components 506, 512, and 514 may be implemented as multiple ICs contained within a single PC while graphics processor 504 and components 508 and 516 may be implemented in a separate device such as a television coupled to host processor 502 and components 506, 512, and 514 through communications pathway 510.

Host processor 502 may comprise a special purpose or a general purpose processor including any control and/or processing logic, hardware, software and/or firmware, capable of providing graphics processor 504 with 3D graphics data and/or instructions. Processor 502 may perform a variety of 3D graphics calculations such as 3D coordinate transformations, etc. the results of which may be provided to graphics processor 504 over bus 510 and/or that may be stored in memories 506 and/or 508 for eventual use by processor 504.

In one implementation, host processor 502 may be capable of performing any of a number of tasks that support the dynamic selection of high-performance pixel shader code based on check of restrictions. These tasks may include, for example, although the invention is not limited in this regard, providing 3D graphics data to graphics processor 504, placing two or more versions of pixel shader rendering code in memory 508, downloading microcode to processor 504, initializing and/or configuring registers within processor 504, interrupt servicing, and providing a bus interface for uploading and/or downloading 3D graphics data. In alternate implementations, some or all of these functions may be performed by graphics processor 504. While FIG. 5 shows host processor 502 and graphics processor 504 as distinct components, the invention is not limited in this regard and those of skill in the art will recognize that processors 502 and 504 possibly in addition to other components of system 500 may be implemented within a single IC.

Graphics processor 504 may comprise any processing logic, hardware, software, and/or firmware, capable of processing graphics data. In one implementation, graphics processor 504 may implement a 3D graphics architecture capable of processing graphics data in accordance with one or more standardized rendering application programming interfaces (APIs) such as OpenGL 2.0™ (“The OpenGL Graphics System: A Specification” (Version 2.0; Oct. 22, 2004)) and DirectX 9.0™ (Version 9.0c; Aug. 8, 2004) to name a few examples, although the invention is not limited in this regard. Graphics processor 504 may process 3D graphics data provided by host processor 502, held or stored in memories 506 and/or 508, and/or provided by sources external to system 500 and obtained over bus 510 from interfaces 512 and/or 514.

Graphics processor 504 may receive 3D graphics data in the form of 3D scene data and process that data to provide image data in a format suitable for conversion by display processor 516 into display-specific data. In addition, graphics processor 504 may implement a variety of 3D graphics processing components and/or stages (not shown) such as an applications stage, a geometry stage and/or one or more texture samplers. Pixel shaders implemented by graphics processor 504 may use high performance or low performance rendering code stored or held in either or both of memories 506 and 508. Further, in accordance with some implementations of the invention, graphics processor 504 may, in conjunction with a set-up kernel executing on system 500, implement, for each graphics primitive processed by processor 504, a check on restrictions to enable dynamic selection of high-performance pixel shader code.

Bus or communications pathway(s) 510 may comprise any mechanism for conveying information (e.g., graphics data, instructions, etc.) between or amongst any of the elements of system 500. For example, although the invention is not limited in this regard, communications pathway(s) 510 may comprise a multipurpose bus capable of conveying, for example, instructions (e.g., macrocode) between processor 502 and processor 504. Alternatively, pathway(s) 510 may comprise a wireless communications pathway.

Display processor 516 may comprise any processing logic, hardware, software, and/or firmware, capable of converting rasterized image data supplied by graphics processor 504 into a format suitable for driving a display (i.e., display-specific data). For example, while the invention is not limited in this regard, processor 504 may provide image data to processor 516 in a specific color data format, for example in a compressed red-green-blue (RGB) format, and processor 516 may process such RGB data by generating, for example, corresponding LCD drive data levels etc. Although FIG. 5 shows processors 504 and 516 as distinct components, the invention is not limited in this regard, and those of skill in the art will recognize that, for example, some if not all of the functions of display processor 516 may be performed by graphics processor 504 and/or host processor 502.

Thus, in accordance with some implementations of the invention, a higher-performance graphics framework may be implemented which allows for rendering under certain restrictions at a much higher rate by reducing the data width sent across internal busses or used in calculations. By defining two versions of pixel rendering or shading code, one which uses the high-performance framework and another, low-performance, version which uses full data widths and precision, graphics engines in accordance with the invention can dynamically choose between the code versions on a per-primitive basis. In accordance with some implementations of the invention a combination of hardware and software threads running on execution units may determine at run time which version of the code is used for each primitive being rendered.

While the foregoing description of one or more instantiations consistent with the claimed invention provides illustration and description of the invention it is not intended to be exhaustive or to limit the scope of the invention to the particular implementations disclosed. Clearly, modifications and variations are possible in light of the above teachings or may be acquired from practice of various implementations of the invention. For example, while FIG. 1 and the accompanying text may show and describe a single pixel sampler 106, those skilled in the art will recognize that data processors in accordance with the invention may include rendering engines that employ multiple pixel shaders, each operating in accordance with the invention. Clearly, many other implementations may be employed to provide for the dynamic selection of high-performance pixel shader code based on check of restrictions consistent with the claimed invention.

No device, element, act, data type, instruction etc. set forth in the description of the present application should be construed as critical or essential to the invention unless explicitly described as such. Also, as used herein, the article “a” is intended to include one or more items. Moreover, when terms or phrases such as “coupled” or “responsive” or “in communication with” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
receiving a graphics primitive for rendering;
determining whether the graphics primitive satisfies a restriction; and
selecting from at least two versions of rendering code a first version of rendering code to render the graphics primitive if the graphics primitive satisfies the restriction.

2. The method of claim 1, wherein the graphics primitive comprises a contiguous block of pixels having texture coordinates and screen coordinates and wherein the graphics primitive satisfies the restriction if a rate of change between texture coordinates of adjacent pixels in the block of pixels is equivalent to a rate of change between screen coordinates of the adjacent pixels.

3. The method of claim 1, further comprising:
selecting a second version of rendering code to render the graphics primitive if the graphics primitive does not satisfy the restriction.

4. The method of claim 3, wherein the second version of rendering code comprises pixel shader code suited to rendering a graphics primitive having a floating point data format.

5. The method of claim 1, wherein the first version of rendering code comprises pixel shader code suited to rendering a graphics primitive having a fixed point data format or an integer data format.

6. The method of claim 1, further comprising using a software kernel to determine whether the graphics primitive satisfies the restriction.

7. The method of claim 1, wherein the graphics primitive comprises one of a plurality of graphics primitives; and wherein the method further comprises using a combination of hardware and software threads to separately determine whether each graphics primitive of the plurality of graphics primitives satisfies the restriction.

8. The method of claim 1, wherein the graphics primitive satisfies the restriction if the graphics primitive includes texture data having a format other than a floating point format.

9. An article comprising a machine-accessible medium having stored thereon instructions that, when executed by a machine, cause the machine to:
receive a graphics primitive for rendering;
determine whether the graphics primitive satisfies a restriction; and
select from at least two versions of rendering code a first version of rendering code to render the graphics primitive if the graphics primitive satisfies the restriction.

10. The article of claim 9, wherein the graphics primitive comprises a contiguous block of pixels having texture coordinates and screen coordinates and wherein the graphics primitive satisfies the restriction if a rate of change between texture coordinates of adjacent pixels in the block of pixels is equivalent to a rate of change between screen coordinates of the adjacent pixels.

11. The article of claim 9, further having stored thereon instructions that, when executed by a machine, cause the machine to:
select a second version of rendering code to render the graphics primitive if the graphics primitive does not satisfy the restriction.

12. The article of claim 11, wherein the second version of rendering code comprises pixel shader code suited to rendering a graphics primitive having a floating point data format.

13. The article of claim 9, wherein the graphics primitive satisfies the restriction if the graphics primitive includes graphics data having a fixed point data format or an integer data format.

14. The article of claim 9, wherein the graphics primitive satisfies the restriction if the graphics primitive includes texture data having a format other than a floating point format.

15. An apparatus comprising:
selection logic to select one pixel shader algorithm from two or more versions of pixel shader algorithms in response to a graphics primitive meeting a restriction; and
pixel shader logic to render the graphics primitive using the selected pixel shader algorithm.

16. The apparatus of claim 15, wherein the graphics primitive meets the restriction if the graphics primitive includes texture data having a format other than a floating point format.

17. The apparatus of claim 15, wherein the graphics primitive comprises a contiguous block of pixels having texture coordinates and screen coordinates and wherein the graphics primitive meets the restriction if a rate of change between texture coordinates of adjacent pixels in the block of pixels is equivalent to a rate of change between screen coordinates of the adjacent pixels.

18. A system comprising:
a graphics processor at least capable of dynamically selecting one pixel shader algorithm from two or more pixel shader algorithms in response to a graphics primitive meeting a restriction;
a network interface coupled to graphics processor, the network interface to provide graphics data to the graphics processor, the graphics data including the graphics primitive; and
an antenna coupled to the network, the antenna to receive the graphics data.

19. The system of claim 18, wherein the graphics primitive meets the restriction if the graphics primitive includes texture data having a format other than a floating point format.

20. The system of claim 18, wherein the graphics primitive comprises a contiguous block of pixels having texture coordinates and screen coordinates and wherein the graphics primitive meets the restriction if a rate of change between texture coordinates of adjacent pixels in the block of pixels is equivalent to a rate of change between screen coordinates of the adjacent pixels.

21. The system of claim 18, wherein the antenna comprises one of a dipole antenna, a narrowband Meander Line Antenna (MLA), a wideband MLA, an inverted “F” antenna, a planar inverted “F” antenna, a Goubau antenna, or a Patch antenna.
